(19) United States
(12) Patent Application Publication
(10) Pub. No.: US 2018/0034127 A1
(43) Pub. Date: Feb. 1, 2018

(54) PLANAR TYPE MAGIC TEE

(71) Applicant: SOONCHUNHYANG UNIVERSITY INDUSTRY ACADEMY COOPERATION FOUNDATION, Asan-si, Chungcheongnam-do (KR)

(72) Inventors: Dal AHN, Cheonan-si, Chungcheongnam-do (KR); HanJu DO, Pyeongtaek-si, Gyeonggi-do (KR); Heehwang KIM, Incheon (KR); YouNa JANG, Asan-si, Chungcheongnam-do (KR); JongSik LIM, Daejeon (KR)

(73) Assignee: SOONCHUNHYANG UNIVERSITY INDUSTRY ACADEMY COOPERATION FOUNDATION, Asan-si, Chungcheongnam-do (KR)

(21) Appl. No.: 15/549,671

(22) PCT Filed: Dec. 31, 2015
(86) PCT No.: PCT/KR2015/014540

§ 371 Date: Aug. 9, 2017

(30) Foreign Application Priority Data
Feb. 12, 2015 (KR) 10-2015-0021716

(51) Int. Cl. H01P 5/20

(52) U.S. Cl. CPC H01P 5/20

(57) ABSTRACT

A planar type magic tee includes a first coupling unit, a second coupling unit, and transmission lines for connecting the first coupling unit and the second coupling unit to each other in a cascading manner, the transmission lines having different characteristic impedances. The planar type magic tee is capable of solving the problem caused due to the intrinsic limitation in bandwidth of a conventional ring hybrid coupler.

### TECHNICAL FIELD

The present invention relates to a planar type magic tee, and more particularly to a planar type magic tee using 3 dB directional couplers and transmission lines.

### BACKGROUND ART

Coupling is a phenomenon in which alternating current signal energy is transmitted electromagnetically between separate spaces or lines.

A coupler is a device that artificially adjusts the extent of such coupling and arbitrarily adjusts the length of lines and the distance between the lines so as to transmit desired power.

A coupler is usually used in a wireless system. A four-port ring hybrid coupler is a basic microwave device that is widely used in a wireless system. An example of a four-port ring hybrid coupler is shown in FIG. 1.

A conventional ring hybrid coupler is characterized in that two output signals have an in-phase and an out-of-phase depending on the position of an input port [1]. That is, the ring hybrid coupler has high isolation characteristics, is characterized in that the phase difference between two outputs is 0° and 180°, and distributes power in the same ratio. Consequently, the ring hybrid coupler has an advantage in that no element for phase compensation is needed for application to antenna arrays, mixers, and balancing amplifiers.

In the conventional ring hybrid coupler, however, all of the ports are oriented in different directions, and it is difficult to arrange two output ports in the same direction, whereby it is difficult to connect the conventional ring hybrid coupler to other devices of a system. Consequently, there is a limitation in configuring the conventional ring hybrid coupler so as to have a cascading planar structure. As a result, the size of a system including a conventional ring hybrid coupler is inevitably increased.

Meanwhile, it is possible to obtain optimal performance of the conventional ring hybrid coupler at the design frequency, since the conventional ring hybrid coupler has a resonant type structure.

In the case in which frequencies other than the design frequency are selected, however, the amplitude and phase between the output ports deviate from desired values, which acts as a factor that limits the bandwidth of the conventional ring hybrid coupler.

A magic tee or a hybrid tee is a 3 dB coupler that equally distributes an input signal into output ports, like a conventional ring hybrid coupler. However, the structure of the magic tee or the hybrid tee is complicated, and the size of the magic tee or the hybrid tee must be very large in order to support low frequencies. Above all, the magic tee has a three-directional structure, with the result that it is difficult to configure the magic tee so as to have a planar structure using a microstrip line or a strip line, like a conventional ring hybrid coupler. Consequently, the magic tee is not suitable for a planar circuit.

Meanwhile, the conventional ring hybrid coupler is a planar type device that is usually used in a wireless system, since the conventional ring hybrid coupler has in-phase and out-of-phase characteristics. However, the bandwidth of the conventional ring hybrid coupler is limited, since λ/4 transmission lines are used. In addition, the ports are oriented in different directions, whereby it is difficult to configure the conventional ring hybrid coupler so as to have a cascading structure.

### DISCLOSURE

### Technical Problem

Therefore, the present invention has been made in view of the above problems, and it is an object of the present invention to provide a planar type magic tee configured to have a structure in which output ports thereof are oriented in the same direction, two directional couplers are connected to each other in a cascading manner such that the couplers have the greatest bandwidth possible, and transmission lines having different characteristic impedances are formed between the two directional couplers.

### Technical Solution

In accordance with the present invention, the above and other objects can be accomplished by the provision of a planar type magic tee including a first coupling unit, a second coupling unit, and transmission lines, through which the first coupling unit and the second coupling unit are connected to each other in a cascading manner in a planar state, the transmission lines having different characteristic impedances.

The transmission lines may include a first conductor having impedance Z_{A} formed at the first coupling unit and a second conductor having impedance Z_{B} formed at the second coupling unit. The first conductor and the second conductor may be connected to each other.

The first coupling unit and the second coupling unit may be provided with ports having the same impedance.

### Advantageous Effects

As is apparent from the above description, the planar type magic tee according to the present invention is capable of solving the problem caused due to the intrinsic limitation in bandwidth of the conventional ring hybrid coupler. In addition, the planar type magic tee according to the present invention is capable of solving the problem in which it is difficult to connect the conventional ring hybrid coupler to another device due to the difference in direction between the output ports of the conventional ring hybrid coupler.

That is, the planar type magic tee according to the present invention has an in-phase mode and an out-of-phase mode, which are the characteristics of the ring hybrid coupler. In addition, the bandwidth of the planar type magic tee according to the present invention is 97% greater than that of the conventional ring hybrid coupler. Consequently, the planar type magic tee according to the present invention is usefully applicable to various applications, such as a balun.

### DESCRIPTION OF DRAWINGS

FIG. 1 is a manufacturing view of a four-port ring hybrid coupler;

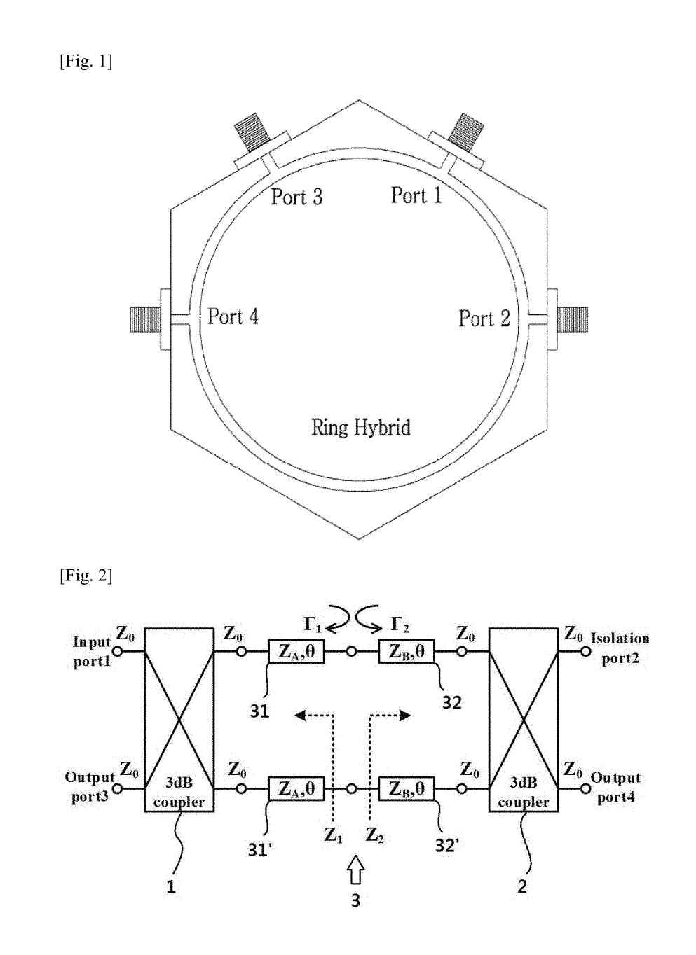

FIG. 2 is an equivalent circuit diagram of a planar type magic tee according to an embodiment of the present invention;

FIG. 3 is a graph showing S-parameter measurement values of the planar type magic tee according to the present invention and the ring hybrid coupler in an in-phase mode and an out-of-phase mode;

FIGS. 4 and 5 are graphs showing the phase difference measurement values of the planar type magic tee according to the present invention and the ring hybrid coupler; and

FIG. 6 is a manufacturing view of the planar type magic tee according to the embodiment of the present invention.

### BEST MODE

The present invention relates to a planar type magic tee using 3 dB directional couplers and transmission lines.

The planar type magic tee according to the present invention is configured such that transmission lines are additionally inserted into a structure in which two directional couplers are connected to each other in a cascading manner. Two output ports have a power of 3 dB. The phase difference between the output ports is an in-phase or an out-of-phase. The bandwidth of the planar type magic tee according to the present invention is 97% greater than that of a conventional ring hybrid coupler.

A description will be given of a change in the phase difference between outputs whenever the characteristic impedances of the four transmission lines, each of which has an electrical length of 90°, connected to the two 3 DB directional couplers of the planar type magic tee according to the present invention are changed. In addition, a description will be given of the power division ratio and desired output values that are obtained by changing a reflection coefficient of the planar type magic tee according to the present invention.

### MODE FOR INVENTION

Hereinafter, the planar type magic tee according to the present invention will be described in detail with reference to the accompanying drawings.

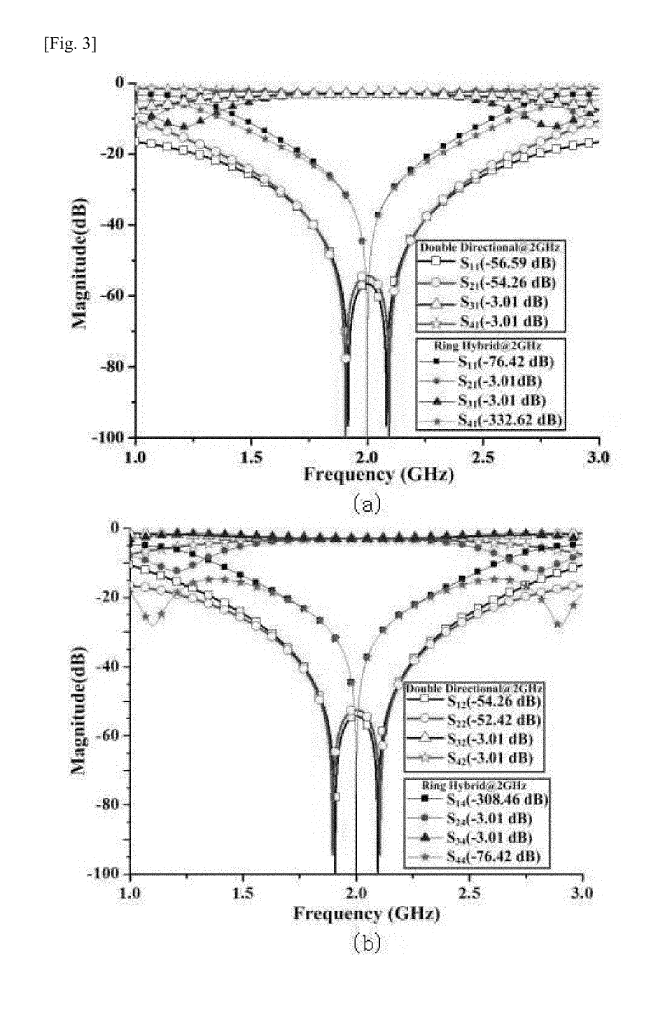

FIG. 2 is an equivalent circuit diagram of a planar type magic tee according to an embodiment of the present invention.

Referring to FIG. 2, the planar type magic tee according to the present invention includes a first coupling unit 1 having four ports, a second coupling unit 2 having four ports, and transmission lines additionally inserted into a structure in which two ports of the first coupling unit 1 and two ports of the second coupling unit 2 are connected to each other in a cascading manner.

In an example, the first coupling unit 1 has an input port, an output port, a P₁₁ port, and a P₁₂ port, and the second coupling unit 2 has an isolation port, an output port, a P₂₁ port, and a P₂₂ port. In this embodiment, the first coupling unit 1 is described as having an input port. Alternatively, the second coupling unit 2 may have an input port, in terms of the functionality thereof. That is, function switching is possible.

Conductors 31 and 31′, each of which has impedance Z_{A}, are formed at sides of the P₁₁ port and the P₁₂ port, respectively, and conductors 32 and 32′, each of which has Z_{B}, formed at sides of the P₂₁ port and the P₂₂ port, respectively. The transmission lines are formed through connection between the conductors.

Conductors formed at the input port, the isolation port, the output port, the P₁₁ port, the P₁₂ port, the P₂₁ port, and the P₂₂ port each have impedance Z₀.

In the planar type magic tee according to the present invention, as described above, two 3 dB directional couplers are connected to each other in a cascading manner, and four λ/4 transmission lines having characteristic impedance Z_{A} or Z_{B} are inserted into the cascading structure. In the case in which Port 1 becomes an input port, Port 2 becomes an isolation port, and Port 3 and Port 4 become output ports that are in phase with each other. In an out-of-phase mode, Port 2 becomes an input port, Port 1 becomes an isolation port, and Port 3 and Port 4 become output ports.

In order to reflect half of an input signal, a reflection coefficient is represented by Equation 1.

$${Γ}_{1 , 2} = \frac{{Z}_{2} - {Z}_{1}}{{Z}_{2} + {Z}_{1}} = \pm \frac{1}{\sqrt{2}} \qquad Equation 1$$

Impedances Z₁ and Z₂ (Z_{1,2}) are represented by Equation 2.

$${Z}_{1 , 2} = {Z}_{A , B} \frac{{Z}_{0} + {jZ}_{A , B} tan β l}{{Z}_{A , B} + {jZ}_{0} tan β l} \qquad Equation 2$$

where j indicates a pure imaginary number, 3 indicates the phase constant of the transmission lines, and 1 indicates the length of the lines.

In the case in which the electrical length of a matching circuit is λ/4 in Equation 2, Z_{A} and Z_{B} are represented by Equations 3 and 4, respectively.

Z_{A}=\sqrt{Z₁Z₀} Equation 3

Z_{B}=\sqrt{Z₂Z₀} Equation 4

In FIG. 2, θ=90°.

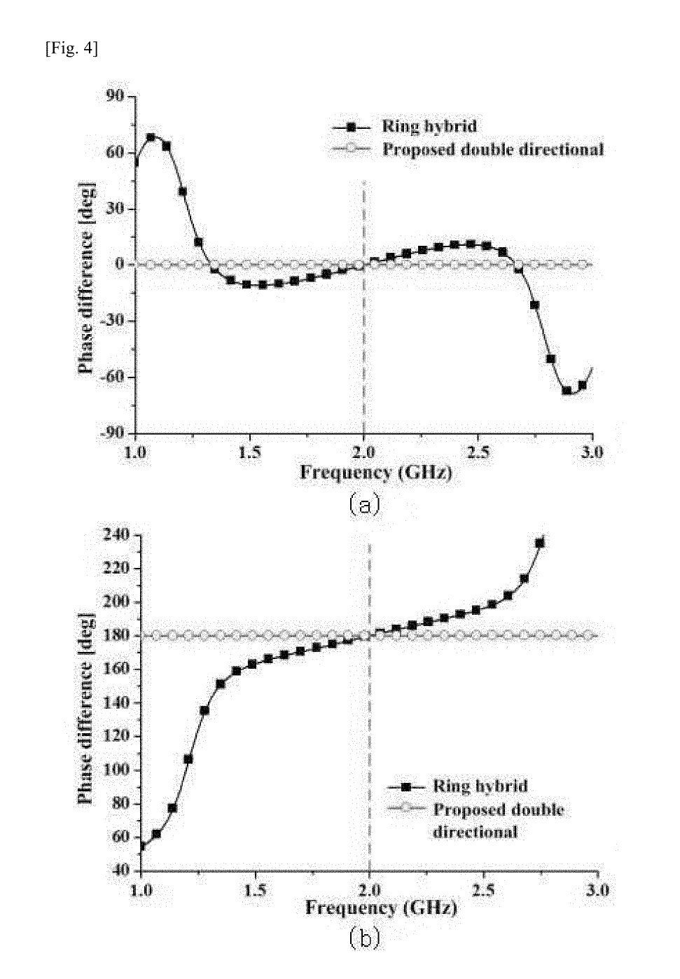

FIG. 3 is a graph showing S-parameter measurement values of the planar type magic tee according to the present invention and the ring hybrid coupler in an in-phase mode and in an out-of-phase mode.

Referring to FIG. 3, there are shown simulation results of the measurement values (magnitude) of the planar type magic tee according to the present invention and the conventional ring hybrid coupler at 2 GHz in an in-phase mode and in an out-of-phase mode, which have been measured using ANSYS Designer 7.0. In FIG. 3(a), S₃₁ and S₄₁ are output ports of the planar type magic tee according to the present invention while S₂₁ and S₃₁ are output ports of the conventional ring hybrid coupler. In the in-phase mode, the planar type magic tee according to the present invention and the conventional ring hybrid coupler have the same output value, 3.01 dB, at 2 GHz. In the out-of-phase mode, as shown in FIG. 3(b), the planar type magic tee according to the present invention and the conventional ring hybrid coupler also have the same output value, 3.01 dB. Meanwhile, in the in-phase mode, the 20 dB fractional bandwidth of the conventional ring hybrid coupler is 27.8%, whereas the 20 dB fractional bandwidth of the planar type magic tee according to the present invention is 74%. That is, it can be seen that the fractional bandwidth of the planar type magic tee according to the present invention is twice or more of the fractional bandwidth of the conventional ring hybrid coupler. In the out-of-phase mode, the 20 dB fractional bandwidth of the conventional ring hybrid coupler is 32.2%, whereas the 20 dB fractional bandwidth of the planar type magic tee according to the present invention is 63.4%. That is, it can be seen that the fractional bandwidth of the planar type magic tee according to the present invention is 97% greater than the fractional bandwidth of the conventional ring hybrid coupler.

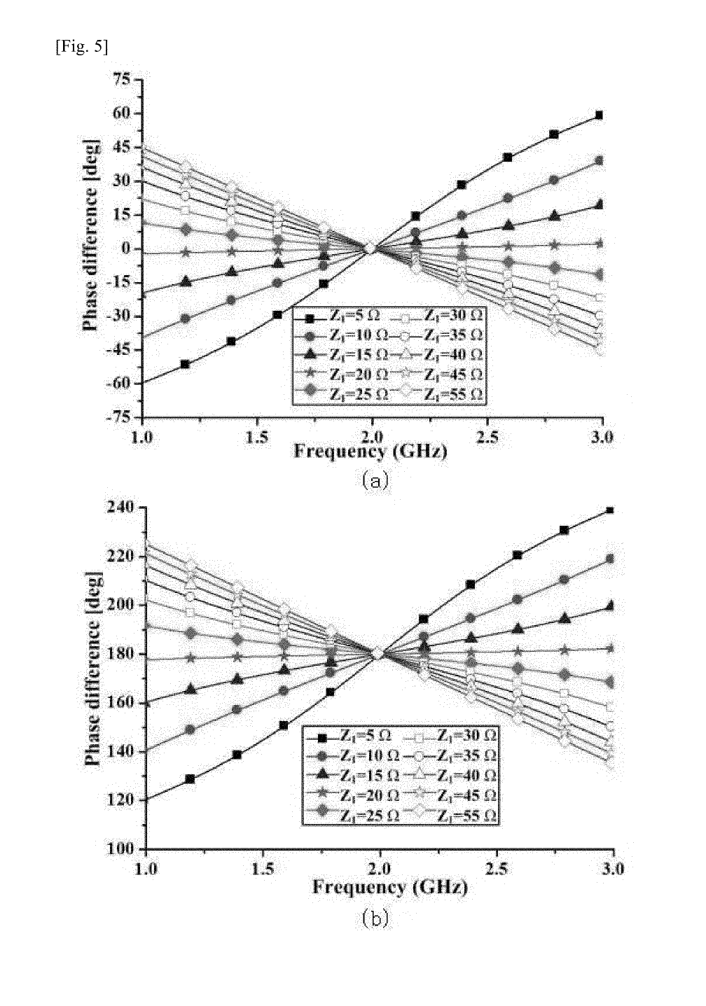

FIGS. 4 and 5 are graphs showing the phase difference measurement values of the planar type magic tee according to the present invention and the ring hybrid coupler.

Specifically, FIGS. 4 and 5 show graphical characteristics of the simulation results in phase difference between the output ports of the planar type magic tee according to the present invention and the ring hybrid coupler in the in-phase mode and the out-of-phase mode.

Referring first to FIG. 4, the in-phase simulation results of FIG. 4(a) reveal that the conventional ring hybrid coupler has in-phase characteristics only at 2 GHz whereas the planar type magic tee according to the present invention has in-phase characteristics over the entire range from 1 GHz to 3 GHz. The out-of-phase simulation results of FIG. 4(b) reveal that the conventional ring hybrid coupler has out-of-phase characteristics only at 2 GHz whereas the planar type magic tee according to the present invention has out-of-phase characteristics over the entire range. Consequently, it can be seen that the planar type magic tee according to the present invention has the function of the conventional ring hybrid coupler and, in addition, has a greater bandwidth than the conventional ring hybrid coupler.

Meanwhile, FIGS. 5(a) and 5(b) show the phase differences between the outputs depending on the values of Z₁.

As shown in FIG. 5, it can be seen that the gradient of the graph changes as Z₁ increases on the basis of Z₁=5Ω. In both FIGS. 5(a) and 5(b), on the basis of Z₁=20.71Ω, the gradient of the graph is greater than 0 when Z₁<20.71Ω, and the gradient of the graph is less than 0 when Z₁>20.71Ω.

As described above, the planar type magic tee according to the present invention is configured such that additional transmission lines are inserted into a structure in which two 3 dB directional couplers are connected to each other in a cascading manner. Having output ports having the same directivity, the planar type magic tee according to the present invention may be realized to have a cascading planar structure. The measurement results (magnitude) and the phase characteristics of the planar type magic tee according to the present invention were theoretically identical to the characteristics of the conventional ring hybrid coupler. Furthermore, in the in-phase mode, the 20 dB fractional bandwidth of the planar type magic tee according to the present invention was twice or more of the fractional bandwidth of the conventional ring hybrid coupler. In the out-of-phase mode, the fractional bandwidth of the planar type magic tee according to the present invention was 97% greater than the fractional bandwidth of the conventional ring hybrid coupler. It could be seen that the phase differences between the output ports are also regularly changed depending on the impedance change of Z₁. It is also possible to change the power division ratio by changing the reflection coefficient, whereby it is also possible to obtain a desired output value. Having the entire functionality of the conventional ring hybrid coupler and, in addition, having a greater bandwidth than the conventional ring hybrid coupler while having a cascading planar structure, therefore, the planar type magic tee according to the present invention may be usefully applied to various applications, such as a balun.

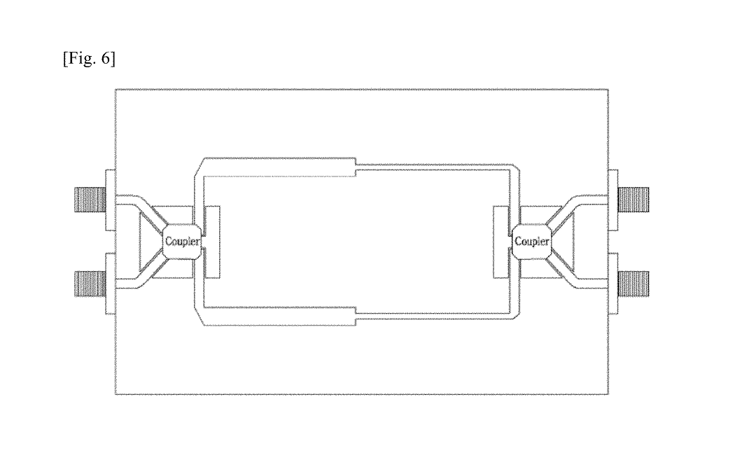

FIG. 6 is a manufacturing view of the planar type magic tee according to the embodiment of the present invention.

Referring to FIG. 6, the planar type magic tee according to the embodiment of the present invention is configured such that the impedances Z₁ and Z₂ formed at the two directional couplers are different from each other. That is, the planar type magic tee according to the embodiment of the present invention is configured such that the impedances formed at the two directional couplers are asymmetrical.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The planar type magic tee according to the present invention has a greater bandwidth than the conventional ring hybrid coupler and, in addition, has a cascading planar structure. Consequently, the planar type magic tee according to the present invention is usefully applicable to various applications, such as a balun.

1. A planar type magic tee comprising:
a first coupling unit;
a second coupling unit; and
transmission lines, through which the first coupling unit and the second coupling unit are connected to each other in a cascading manner in a planar state, the transmission lines having different characteristic impedances.

2. The planar type magic tee according to claim 1, wherein the transmission lines comprise:
a first conductor having impedance Z_{A} formed at the first coupling unit; and
a second conductor having impedance Z_{B} formed at the second coupling unit,
the first conductor and the second conductor being connected to each other.

3. The planar type magic tee according to claim 2, wherein the first coupling unit and the second coupling unit are provided with ports having impedance Z₀.

4. The planar type magic tee according to claim 3, wherein impedance Z_{A} and the impedance Z_{B} are calculated using following equations:
Z_{A}=\sqrt{Z₁Z₀},Z_{B}=\sqrt{Z₂Z₀}
where Z₁ is an impedance of the first coupling unit, Z₂ is an impedance of the second coupling unit, and Z₁ and Z₂ are calculated using a following equation:
$${Z}_{1 , 2} = {Z}_{A , B} \frac{{Z}_{0} + {jZ}_{A , B} tan β l}{{Z}_{A , B} + {jZ}_{0} tan β l}$$
where j indicates a pure imaginary number, 3 indicates a phase constant of the transmission lines, and 1 indicates a length of the lines.
